(19) United States
(12) Patent Application Publication
(10) Pub. No.: US 2006/0242144 A1
(43) Pub. Date: Oct. 26, 2006

(54) Medical image data processing system

(76) Inventors: Matthew Paul Esham, Pennsville, NJ (US); Andrew Chi, King of Prussia, PA (US)

Correspondence Address: Siemens Corporation;Intellectual Property Department, 170 Wood Avenue South, Iselin, NJ, 08830, US

(21) Appl. No.: 11/328,950

(22) Filed: Jan. 10, 2006

Related U.S. Application Data
(60) Provisional application No. 60/664,888, filed on Mar. 24, 2005.

(51) Int. Cl. G06F 17/30

(52) U.S. Cl. 707/6

(57) ABSTRACT

A system determines a most recent medical image study accessed or used by a healthcare worker and identifies the most up to date instance of a medical image study stored in a distributed environment with multiple DICOM storage nodes, for example. A medical image data acquisition and processing system, involves multiple sources of medical image data accessible via a network. The medical image data comprises one or more sets of medical images of a particular patient individually including an associated medical image set identifier. A search processor automatically initiates a search of the multiple sources to identify existence of sets of medical images of a particular patient having a duplicate first medical image identifier, in response to a user command to access a set of medical images having the first medical image identifier. An image data processor, in response to identifying sets of medical images of a particular patient having the duplicate first medical image identifier, determines a set of the sets of medical images likely to have been updated most recently.

This is a non-provisional application of provisional application Ser. No. 60/664,888 by M. P. Esham et al. filed Mar. 24, 2005.

### FIELD OF THE INVENTION

This invention concerns a medical image data acquisition and processing system for processing sets of medical images of a patient and identifying recently updated sets of medical images.

### BACKGROUND OF THE INVENTION

In existing systems multiple image studies provided by an imaging modality (e.g., an MRI, CT scan, X-ray, ultrasound or other imaging device) are displayed to a user to be manually parsed to identify the most recent and current image studies. A DICOM (Digital Imaging and Communications in Medicine protocol standard (developed approximately 1990)) compatible imaging study may comprise multiple different series of images and an individual series of images may have multiple series instances (copies). If multiple instances of a single image study exist on multiple workstations (e.g., multiple DICOM compatible nodes), the multiple instances of the single image study are accessed for display in response to a user query as a separate imaging studies. The user needs to manually examine each image study to see which study is the most up to date, or choose the study from the desired source. This is a burdensome task and may involve a user accessing many images to determine which study is the most recent. This task is also vulnerable to human error. A system according to invention principles addresses these burdens and associated problems.

### SUMMARY OF THE INVENTION

A system enables a user to ensure they are viewing the most recently altered copy of an imaging study and enables merger of multiple copies of an image study. A medical image data acquisition and processing system, involves multiple sources of medical image data accessible via a network. The medical image data comprises one or more sets of medical images (e.g., DICOM compatible image studies) of a particular patient individually including an associated medical image set identifier. A search processor automatically initiates a search of the multiple sources to identify existence of sets of medical images of a particular patient having a duplicate first medical image identifier, in response to a user command to access a set of medical images having the first medical image identifier. An image data processor, in response to identifying sets of medical images of a particular patient having the duplicate first medical image identifier, determines a set of the sets of medical images likely to have been updated most recently.

### BRIEF DESCRIPTION OF THE DRAWING

FIG. 1 shows a medical image study acquisition and distribution system, according to invention principles.

FIG. 2 illustrates medical image processing by the medical image study acquisition and distribution system, according to invention principles.

FIG. 3 shows a flowchart of a process involved in medical image study acquisition and distribution, according to invention principles.

FIG. 4 shows a command and data flow involved in medical image study acquisition and distribution, according to invention principles.

FIG. 5 shows a flowchart of a process employed in medical image study acquisition and distribution, according to invention principles.

### DETAILED DESCRIPTION OF THE INVENTION

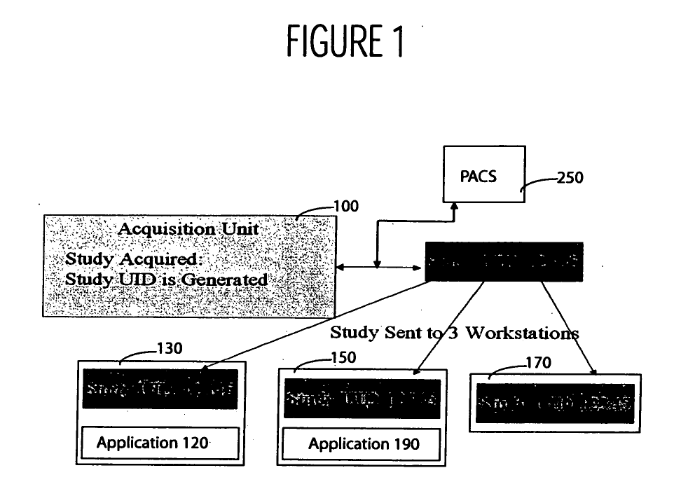

FIG. 1 shows a medical image study acquisition and distribution system enabling a user to ensure the user is viewing the most recent copy of an image study comprising one or more series of medical images of a patient. The system also enables multiple copies of an image study that are substantially identical to be merged. A Query based worklist generator in the system determines whether image studies existing in multiple locations are exact copies and if any updates to individual image studies have occurred. The system advantageously automatically informs a user that a particular image study produced by a particular radiological examination of a patient, for example, has been previously processed and a new image series has been created within the particular image study.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

A medical image acquisition and distribution unit 100 (FIG. 1) associated with an imaging modality device (an MRI, CT scan, X-ray, ultrasound or other imaging device) acquires a medical image study in DICOM compatible format (or non-DICOM format in another embodiment) and generates a Unique Identifier (UID), e.g., 12345, and associates the UID with the acquired image study. System 100 comprises one or more executable applications that are located in a centralized server accessed by workstations 130, 150 and 170, for example, or may be located in any other units in the FIG. 1 system. System 100 may comprise applications 120 and 190 located in workstations 130 and 150 respectively. Applications 120 and 190 alternatively may be located in any device in FIG. 1 or may be distributed amongst different devices in FIG. 1. Modality acquisition unit 100 distributes the image study with UID 12345 to workstations 130, 150 and 170. Modality acquisition unit 100 stores the acquired image study in DICOM compatible hierarchical format comprising one or more image Series individually comprising one or more image Series Instances. An individual image Study comprises a hierarchical dataset that may have multiple image Series and an individual image Series may have multiple Instances. Each level of the hierarchical dataset has a field for a unique identifier (UID). For a hospital (or other healthcare) entity image acquisition system, UIDs are specific to a hierarchical dataset level they are assigned to and an individual image Series has a UID that is different to other image Series regardless of the patient or image study that it belongs to.

Image studies acquired by modality acquisition unit 100 may be forwarded to workstations 130, 150 and 170 or to a Picture Archiving Computer System (PACS) 250. Acquisition unit 100 is typically statically configured for a specific healthcare site to automatically process newly acquired image studies such as by automatically forwarding them to a workstation, for example. Workstations 130, 150 and 170 enable a clinician to do further post-processing of the image study with UID 12345. However, because there are multiple copies of the same study being processed by different workstations 130, 150 and 170, an issue of synchronization now arises. One or more physicians may make additions to the image study with UID 12345 on different workstation 130, 150 and 170 creating image studies that are no longer the same. The post-acquisition processing of a DICOM compatible image study results in the creation of new image series (containing new Instances). DICOM compatible image Series or Instances are not supposed to be modified or deleted. However, the DICOM standard fails to provide a straightforward means for merging image studies to create a single image study that reflects post-processing additions and alterations that may have been performed as for example on the image study with UID 12345 on different workstation 130, 150 and 170. In existing systems, in order to merge two image studies, for example, to create a single image study, a clinician has the burden of loading both studies and performing a manual comparison of each series and instance.

In an optimal environment, an acquisition unit such as unit 100 sends image studies to a PACS unit and workstations directly review the studies acquired from the PACS unit. This direct review allows a workstation to read an image study from the PACS unit, make changes to the image study and have those changes reflected substantially immediately back into the PACS unit. This keeps an image study in synchronization so an image study stored in the PACS unit is the most recent. However, in many real-life deployments, the optimal environment is not available. Hospitals may not have a PACS unit, or perhaps direct image study review is not supported, or a centralization arrangement may not be established due to various deployment-specific constraints. System 100 addresses these problems and deficiencies in a low cost, low-impact manner (avoiding a need to purchase a new PACS unit or support direct review) by employing a simple protocol not currently supported by DICOM.

System 100 tracks the most recent image study. The most recent image study is an image study that was last (most recently) post-processed by a clinician. System 100 is advantageously aware of the UID of the image study that was the last post-processed and system 100 is therefore able to provide a clinician with the most recent image study in response to a request. In response to an image study being loaded, system 100 advantageously automatically searches data sources (PACS, repositories, databases or workstations) to see if an image study with the same UID is present. In response to searching these data sources, candidate replicated image studies are identified. System 100 determines which of the candidate image studies is the most recently post-processed for use by a clinician. Consequently, system 100, by tracking the most recent image study, addresses the problem of image study synchronization.

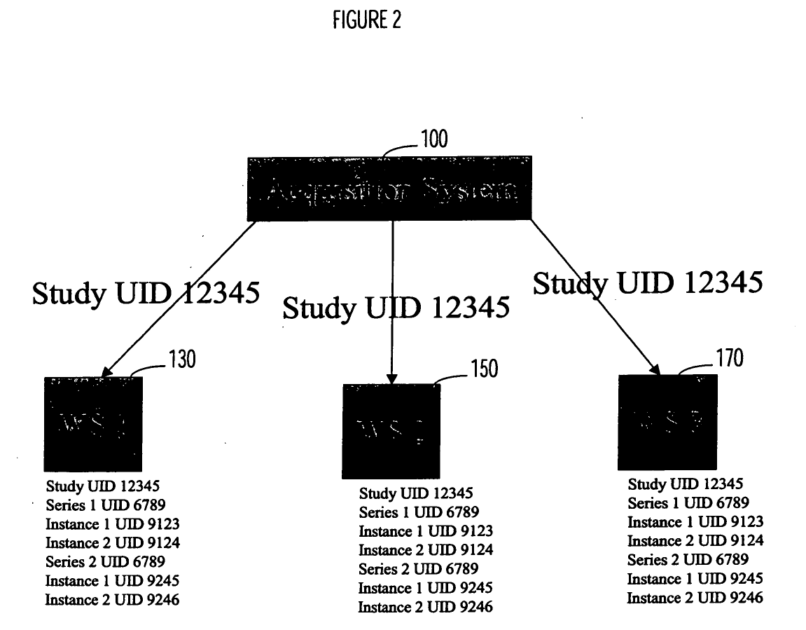

FIG. 2 illustrates medical image processing by medical image study acquisition and distribution system 100. In an example of operation, workstations 130, 150 and 170 initially individually store an identical image study data set representing an image study with UID 12345. A UID is a DICOM compatible term, for example, comprising an identifier assigned to a new image study that is acquired by system 100. However, subsequent copies of the image study with UID 12345 may be post processed and be different (i.e., UID 12345 does not uniquely identify post-processed modified image study copies) and it is a user responsibility to manage identification of copies and synchronize data so a user can identify a most recently post-processed copy. The capability of creating a UID is restricted to being performed by an acquisition system such as system 100 and a PACS unit, for example. An acquisition system such as system 100 does not typically have a capability to regulate (i.e., monitor, track and individually identify) image study copies or information that was added or deleted from an individual copy and does not know the copies exist.

An image study UID, Series UID, and Instance UID, once created is static and is not updated or changed. System 100 creates a UID for each image study it acquires and generates a first UID for an acquired first image study of a particular patient and a second UID for an acquired second image study. When a copy of an image study is pushed from acquisition system 100 to multiple workstations (such as workstations 130, 150 and 170), each copy received by workstations 130, 150 and 170 is identical at this point in time and comprises an exact image study copy with the same UID 12345. The image study with UID 12345 comprises two image series each with UID 6789. The first image series comprises first and second image series instances with UIDs of 9123 and 9124 respectively. The second image series comprises first and second image series instances with UIDs of 9245 and 9246 respectively. A user may post-process the images of the image study at each workstation and save the resulting data and each study retains the same image study UID of 12345 that is not changed even though workstations 130, 150 and 170 have individually stored different image study data. A system in unit 100 advantageously enables a user to know which of the workstations 130, 150 and 170 stores the most up to date (most recently altered) image study copy.

In contrast existing systems require a user to review each image study copy and parse it manually to determine the most up to date image study copy. In an existing system, a first user post-processes the image study with UID 12345 on workstation 130 and creates a third image series with a UID of 78910. Similarly, different users operating workstations 150 and 170 post process the image study to create new different image series respectively. Workstations 130, 150 and 170 are individual separate entities in the distributed environment of FIG. 2 and individual created different image series stored by respective workstations 130, 150 and 170 respectively are substantially similar and have corresponding different series UIDs. In existing systems there is no synchronization of data across distributed DICOM nodes such as workstations 130, 150 and 170. In an existing system, another (fourth) user that desires to access a specific piece of data in an image study needs to parse through the image studies stored by workstations 130, 150 and 170 to find the image series the user is looking for. The fourth user may process the located study and create a fourth mage study (also substantially similar to the other three stored by workstations 130, 150 and 170) and may either store four copies of the image study (each with image study UID 12345) that are substantially similar, or initiate merger of the four image studies back into a common single image study.

In contrast, system 100 advantageously generates and employs a checksum of data comprising image series and series instance identifiers (or in another embodiment a different function of these identifiers). The checksum facilitates identification by system 100 of different (non-alike) image studies. System 100 also advantageously uses series instance count values (i.e. count values determining the number of image series in an image study, the number of instances in an image series and the number of images in an image series instance) to determine if data has been added to an image study. System 100 also uses a last modified indicator attribute, e.g., indicating a time and date when an image study was modified. System 100 advantageously employs proprietary data elements including the checksum and count values, for example, and incorporates them in a Private DICOM compatible data field. The data elements are stored in a standard DICOM format comprising data fields accommodating data in an exemplary format:
0000,0000;string;string;string;string
   The zeros identify the private DICOM element e.g., a private DICOM element tag assignment and the “;string” fields identify the data elements in sequential order.

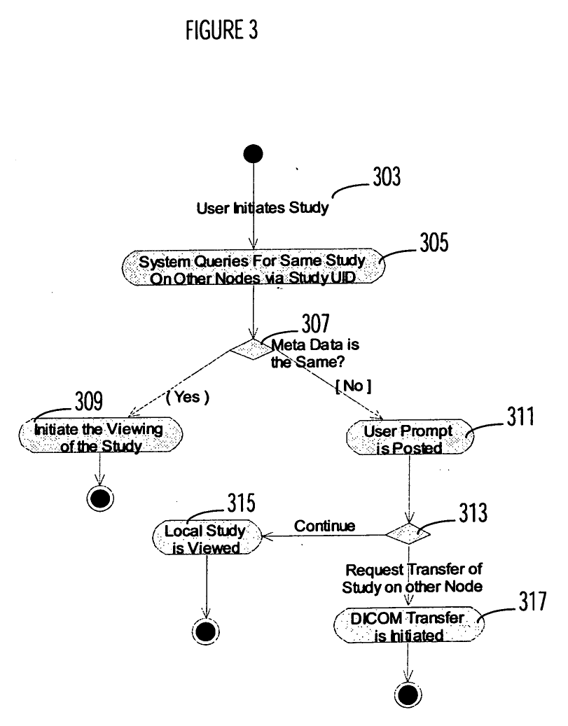

FIG. 3 shows a flowchart of a process employed by system 100 (FIGS. 1 and 2) in medical image study acquisition, processing and distribution. In step 303, a user initiates viewing of an image study with UID 12345 on workstation 130, accessed from a local database. In step 305 system 100 queries system nodes, specifically workstations 130, 150 and 170 to identify presence of other image studies with UID 12345, for example and to acquire metadata concerning identified image studies with UID 12345. System 100 also derives metadata from the image studies. Metadata of an image study is ancillary data associated with an image study including data indicating one or more of, a last modified date, a last modified time, a number of image series in an image study, a number of series instances in an image series, a number of images in an image series instance and a function (e.g., a checksum) of image identifier values associated with an image, study, series or instance. In step 307, system 100 automatically compares metadata of image studies identified in step 305 in response to a request to view an image study. If the metadata compared in step 307 is the same for the multiple identified image studies, the user initiates viewing of the image study with UID 12345 on workstation 130 in step 309 previously accessed from the local database in step 303. If the metadata compared in step 307 is different, a prompt message is generated and communicated to a user in step 311 indicating multiple different images studies with common UID 12345 exist and specifically a newer image study exists. The newer image study being derived in response to physician examination of a study with UID 12345, for example. The prompt message is communicated to a user by reproduction on a display device, or by Email, voice message via phone or pager or by other methods.

In response to a received prompt message in step 311, a user in step 313 determines whether to continue to view the image study with UID 12345 on workstation 130 previously accessed from the local database or to request transfer of another image study, the most recently modified image study, for access and viewing. In step 315, a user views the local image study with UID 12345 on workstation 130 previously accessed from the local database even though it is not the most recent if the user elects to continue with viewing in step 313. In step 317, a user initiates DICOM protocol transfer of the most recently modified image study for access and viewing if the user elects to access the other image study in step 313.

System 100 determines the most recently modified image study and enables a user in a distributed DICOM environment, to determine the status of an image study stored in a local workstation or repository. System 100 determines the most recently modified image study and allows a processor (e.g., including a task worklist generator) to query image study repositories and to accurately automatically merge identical image studies stored by multiple workstations and display one representation of the merged image study to a user. In contrast, if the same image study is stored on each workstation it is displayed multiple times in an existing system. System 100 may be used in any distributed DICOM imaging environment where multiple copies of image studies exist on different workstations acting as individual DICOM nodes.

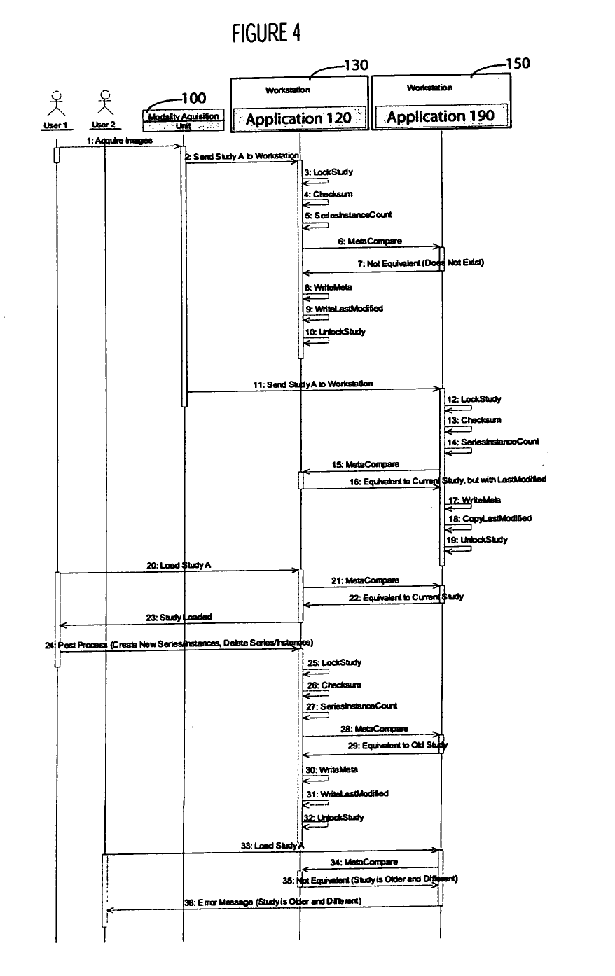

FIG. 4 shows an automatically performed command and data flow involved in medical image study acquisition, processing and distribution by system 100. In step 1 system 100 acquires data representing a first image study in response to command by a first user and system 100 in step 2 communicates the first image study to workstation 130 as directed by pre-configured auto-transfer rules in system 100.

Executable application 120 operating on workstation 130 in step 3 locally locks the first image study by securing the image study to prevent write access to the first image study so that no one may make changes to it during a Checksum operation and Count operation. In step 4 application 120 determines a Checksum of the first image study identifiers specifically of image series and series instance identifiers (or in another embodiment a different function of these identifiers) and in step 5 application 120 determines count values (i.e. count values comprising a SeriesInstanceCount determining the number of image series in an image study, the number of instances in an image series and the number of images in an image series instance).

In step 6 application 120 compares Metadata of the first image study including Checksum, SeriesInstanceCount and OldLastModified indicator (indicating when an image study was last modified) of a local stored first image study on workstation 130 with any other first image study copies available on workstation 150. At step 6 the local first image study OldLastModified indicator is a Null value since this is the first time the first image study has been available on workstation 130. Application 120 in step 7 determines that the result of the step 6 comparison indicates no differences are found since no copy of the first image study exists on workstation 150 or other workstations following interrogation of these workstations. In step 8 application 120 writes the Checksum and SeriesInstanceCount to local storage and in step 9 writes the OldLastModified indicator to local storage. Application 120 in step 10 unlocks the first image study stored by workstation 130 in local storage for general usage and in response to predetermined Autotransfer Rules, system 100 in step 11 communicates a copy of the first image study to Workstation 150. Executable application 190 operating on workstation 150 in step 12 locally locks the received copy of the first image study so that no one can make changes to it.

Application 190 in step 13 determines a Checksum of the received copy of the first image study of image series and series instance identifiers (or in another embodiment a different function of these identifiers) and in step 14 application 190 determines count values comprising a SeriesInstanceCount determining the number of image series in the received copy of the first image study, the number of instances in the image series and the number of images in an image series instance). In step 15 application 190 compares Metadata of the received copy of the first image study including Checksum, SeriesInstanceCount and OldLastModified indicator with corresponding metadata of the first image study stored by workstation 130. At step 16 the received first image study OldLastModified indicator is determined to be a Null value since this is the first time the received copy of the first image study has been available on workstation 150. This is compared with the OldLastModified indicator of the first image copy locally stored by workstation 130 which is now set to a substantially current time and date value since the first image study was processed by workstation 130. The comparison of OldLastModified indicators indicates no difference of consequence. The step 16 comparison indicates no significant differences are found between the first image study copy received by workstation 150 and the first image study stored by workstation 130 following interrogation of workstation 130 and any other workstations. In step 17 application 190 of workstation 150 writes the Checksum and SeriesInstanceCount to local storage and in step 18 copies and stores the OldLastModified indicator of the first image study of workstation 130 (since the workstation 150 local first image study has OldLastModified equal to a Null value and the workstation 130 indicator is already set). Application 190 in step 19 unlocks the first image study, stored by workstation 150 in local storage, for general usage.

User 1 in step 20 initiates access and loading e.g., from system 100 of an image study (study A) for viewing and post-processing by workstation 130. Application 120 in step 21 initiates communication with other workstations and compares the metadata (Checksum, SeriesInstanceCount, and OldLastModified indicator) of image study A with metadata of image studies on workstation 150 and other workstations and determines in step 22 that image study A is the first image study and is the same as the first image study copy stored by workstation 150. Application 120 in step 23 communicates a message to user 1 via workstation 130 indicating image study A is loaded by Application 120 without error. User 1 post-processes and modifies image study A by creating a new image series and instance or by deleting an image series or instance in step 24 in response to user command. Application 120 operating on workstation 130 in step 25 locally locks the post-processed image study A so that no one can make changes to it. System 100 and applications 120 and 190 may alternatively comprise a single executable application that is located in a centralized server accessed by workstations 130, 150 and 170 of FIG. 1, for example, or may be located in any other units in the FIG. 1 system. Applications comprising system 100 may alternatively be located in any device in FIG. 1 or may be distributed amongst different devices in FIG. 1.

Application 120 in step 26 determines a Checksum of the post-processed image study A image series identifiers and series instance identifiers (or in another embodiment a different function of these identifiers). In step 27 application 120 determines count values comprising a SeriesInstanceCount determining the number of image series in post-processed image study A, the number of instances in the image series and the number of images in an image series instance. In step 28 application 120 compares metadata of post-processed image study A including Checksum, SeriesInstanceCount and OldLastModified indicator with corresponding metadata of the first image study stored by workstation 150 in steps 13 and 14. At step 29 application 120 determines there are no substantial differences merely a benign safe difference. The studies are different because of post-processing in step 24, but application 120 determines the Checksum, SeriesInstanceCount, and OldLastModified indicator match and as a result, there is no need to merge the compared images studies.

In steps 30 and 31 application 120 writes the Checksum, SeriesInstanceCount and OldLastModified indicator of post-processed image study A to local storage. Application 120 in step 32 unlocks post-processed image study A, stored by workstation 120 in local storage, for general usage. User 2 in step 33 initiates access and loading of an image study (study A) e.g., from system 100 for viewing and post-processing by workstation 150. Application 190 in step 34 initiates communication with other workstations and compares the metadata (Checksum, SeriesInstanceCount, and OldLastModified indicator) of image study A with metadata of image studies on workstation 130 and other workstations and determines in step 35 that image study A is older and different than the post-processed image study A (post-processed in step 24) stored by workstation 130. Application 190 in step 36 communicates a message to user 2 via workstation 150 indicating there is a newer different copy of image study A available stored by workstation 130.

The system advantageously marks individual image studies with proprietary information in order to keep track of a most recently modified image study. The proprietary information acts as a flag enabling quick and efficient comparison of studies. The proprietary information includes a recent study checksum that comprises a checksum of concatenated image series and instance UIDs. The checksum is used by the system to quickly determine whether two image studies are the same. This checksum is determined for different Instance UIDs of a study. so if there is a different image Instance between two image studies, they are considered to be different. The checksum is used to identify like studies image and enables both a system and a user to determine if a copy of an image study being viewed is the most current (recently altered) image study based on a concatenation of series and instance UIDs, for example. The system uses this checksum instead of a “last viewed” indicator as the last viewed indicator does not indicate an image study has been post processed and modified and is the most recently altered image study. Also the recent study checksum allows a PACs or other system to identify and accurately merge like image studies.

The system employs an image series count and an instance count that identifies a number of image series and instances within an image study to enable determination of which image study or series has received post processing. The system incorporates logic determining whether, and how, to merge image studies based on checksum values, such that like image studies are merged without incorporating redundant additional image data. The system logic queries other DICOM compatible nodes (e.g. workstations 130, 150 and 170 and PACS unit 250 of FIG. 1) for a selected image study and compares image study metadata. The logic allows a user to view a local image study, or request the transfer of a different copy of the same image study from another node. The system may also be implemented in a classic DICOM environment without a centralized Archive to maintain synchronized image studies across multiple different workstations, for example.

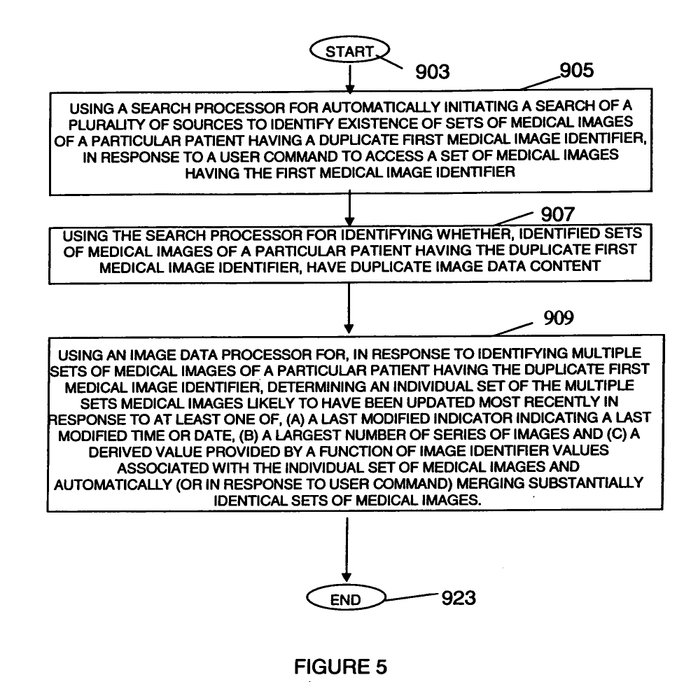

FIG. 5 shows a flowchart of a process employed by system 100 of FIG. 1 (or applications 120 and 190 of FIG. 4), for example, in medical image study acquisition and distribution. A search processor in system 100 in step 905, following the start at step 903, automatically initiates a search of multiple sources to identify existence of sets of medical images of a particular patient having a duplicate first medical image identifier, in response to a user command to access a set of medical images having the first medical image identifier. The multiple sources of medical image data comprise one or more sets of medical images of a particular patient individually including an associated medical image set identifier and are accessible via a network. The sets of medical images are DICOM compatible group of images comprising at least one of, (i) an image study, (b) a series of images, (ii) an instance of a series of images and the first medical image identifier is a DICOM compatible medical image set identifier, for example. The search processor in step 907 identifies whether, identified sets of medical images of a particular patient having the duplicate first medical image identifier, have duplicate image data content.

In step 909 system 100 employs an image data processor for, in response to identifying medical image studies of a particular patient having the duplicate first medical image identifier, determining a set of the sets of medical images likely to have been updated most recently in response to at least one of, (a) a last modified indicator indicating a last modified time or date, (b) a largest number of series of images and (c) a derived value provided by a function of image identifier values associated with individual studies of the identified sets of medical images. The last modified indicator includes a last modified date and a last modified time, associated with a set of medical images comprising, an individual medical image, a series of images, an instance of a series of images and a medical image study. The image data processor performs its functions automatically but in a further embodiment performs one or more functions in response to user command.

The image data processor determines a set of the sets of medical images likely to have been updated most recently in response to the largest value of the number of one or more of, series of images, instances of series of images and individual images, in a set of medical images. The image processor also determines sets of the identified sets of medical images likely to have duplicate image data content and that are substantially identical as well as an individual set that has been updated most recently in response to a derived value provided by a function (e.g., a checksum) of image identifier values associated with the individual set of medical images. The function of image identifier values is a function of image identifiers associated with at least one of, (i) a series of images, (ii) an instance of a series of images and (iii) an individual image. The image data processor merges identified sets of medical images determined to be substantially identical. The process of FIG. 5 terminates at step 923.

System 100 (FIG. 1) maintains and tracks a last modified date and maintains a record of the number of the image series and instances in an image study. Further, in response to a clinician post-processing image data of a study, a new image series or instance is created and an event message is communicated from workstation 130 on which the new image series or instance is created indicating occurrence of the creation. System 100 monitors communications for such event messages and marks a study with a current date and time and thereby keeps track of when it was last modified. In an example, two image studies having the same Study UID (e.g., 12345) are compared. A checksum comparison is performed to determine whether the two image studies are internally identical. If it is determined the two image studies are not the same, the most recently altered image study of the two is heuristically determined based on an acquisition timestamp.

However, the timestamp may not reliably indicate the most recently altered study. Therefore system 100 advantageously heuristically determines which study is likely to be most recently altered based on a record of the number of the Series and Instances in a study because the most recently modified study is likely to have more image Series or Instances (under the DICOM convention).

The system and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and processes of FIGS. 1-5 may be implemented in hardware, software or a combination of both. The system searches data sources and compares image studies whenever an image study is accessed and loaded by a workstation, for example, in order to address image version synchronization issues. The system maintains and tracks proprietary information for the purpose of performing quick and efficient image study comparisons and reduces the need for a clinician to load two image studies and perform a manual comparison of individual image series and instances. The system determines when image studies are the same and advantageously reduces storage space by accurately automatically merging studies and discarding redundant duplicate studies.

What is claimed is:

1. A medical image data acquisition and processing system, comprising:
a plurality of sources of medical image data accessible via a network, said medical image data comprising one or more sets of medical images of a particular patient individually including an associated medical image set identifier;
a search processor for automatically initiating a search of said plurality of sources to identify existence of sets of medical images of a particular patient having a duplicate first medical image identifier, in response to a user command to access a set of medical images having said first medical image identifier; and
an image data processor for, in response to identifying sets of medical images of a particular patient having said duplicate first medical image identifier, determining a set of said sets of medical images likely to have been updated most recently.

2. A system according to claim 1, wherein
said image data processor determines said set of said sets of medical images likely to have been updated most recently in response to modification data associated with a set of medical images, said modification data comprises at least one of, (a) a last modified date and (b) a last modified time, associated with a set of medical images.

3. A system according to claim 2, wherein
said modification data is associated with at least one of, (i) an individual medical image, (ii) a series of images and (iii) an instance of a series of images.

4. A system according to claim 1, wherein
said image data processor determines said set of said sets of medical images likely to have been updated most recently by determining a number of at least one of, (i) series of images, (ii) instances of series of images and (iii) individual images, in a set of medical images.

5. A system according to claim 4, wherein
said image data processor determines said set of said sets of medical images likely to have been updated most recently as being a set having the largest value of said number.

6. A system according to claim 1, wherein
said search processor identifies whether, identified sets of medical images of a particular patient having said duplicate first medical image identifier, have duplicate image data content.

7. A system according to claim 6, wherein
said search processor identifies whether, identified sets of medical images of a particular patient having said duplicate first medical image identifier, have duplicate image data content in response to a value derived by a function of image identifier values associated with said identified sets.

8. A system according to claim 7, wherein
said function of image identifier values is a function of image identifiers associated with at least one of, (i) a series of images, (ii) an instance of a series of images and (iii) an individual image.

9. A system according to claim 8, wherein
said function is a checksum.

10. A system according to claim 1, wherein
said sets of medical images are DICOM compatible group of images comprising at least one of, (i) an image study, (b) a series of images, (ii) an instance of a series of images and
said first medical image identifier is a DICOM compatible medical image set identifier.

11. A system according to claim 1, wherein
said image data processor merges said identified sets of medical images having said duplicate first medical image identifier based on a determination said identified sets of medical images having said duplicate first medical image identifier are substantially identical in response to at least one of, (a) a last modified indicator indicating a last modified time or date, (b) a largest number of series of images and (c) a derived value provided by a function of image identifier values associated with individual studies of said identified medical image studies.

12. A medical image data acquisition and processing system, comprising:
a plurality of sources of medical image data accessible via a network, said medical image data comprising one or more sets of medical images of a particular patient individually including an associated medical image set identifier;
a search processor for,
automatically initiating a search of said plurality of sources to identify existence of sets of medical images of a particular patient having a duplicate first medical image identifier, in response to a user command to access a set of medical images having said first medical image identifier and
identifying whether, identified sets of medical images of a particular patient having said duplicate first medical image identifier, have duplicate image data content; and
an image data processor for, in response to identifying sets of medical images of a particular patient having said duplicate first medical image identifier, determining a set of said sets of medical images likely to have been updated most recently.

13. A system according to claim 12, wherein
said search processor identifies whether, identified sets of medical images of a particular patient having said duplicate first medical image identifier, have duplicate image data content in response to a derived value provided by a function of image identifier values associated with said identified sets.

14. A system according to claim 13, wherein
said function of image identifier values is a function of image identifiers associated with at least one of, (i) a series of images, (ii) an instance of a series of images and (iii) an individual image.

15. A system according to claim 14, wherein
said function is a checksum.

16. A system according to claim 12, wherein
said image data processor determines said set of said sets of medical images likely to have been updated most recently in response to modification data associated with a set of medical images, said modification data comprises at least one of, (a) a last modified date and (b) a last modified time, associated with a set of medical images.

17. A system according to claim 16, wherein
said modification data is associated with at least one of, (i) an individual medical image, (ii) a series of images and (iii) an instance of a series of images.

18. A system according to claim 12, wherein
said image data processor determines said set of said sets of medical images likely to have been updated most recently by determining a number of at least one of, (i) series of images, (ii) instances of series of images and (iii) images in an individual set of medical images.

19. A system according to claim 18, wherein
said image data processor determines said set of said sets of medical images likely to have been updated most recently as being a set having the largest value of said number.

20. A medical image data acquisition and processing system, comprising:
a plurality of sources of medical image data accessible via a network, said medical image data comprising one or more medical image studies of a particular patient individually including an associated medical image set identifier, an individual medical image study comprising one or more images series;
a search processor for automatically initiating a search of said plurality of sources to identify existence of medical image studies of a particular patient having a duplicate first medical image identifier, in response to a user command to access a medical image study having said first medical image identifier; and
an image data processor for, in response to identifying medical image studies of a particular patient having said duplicate first medical image identifier, determining a study of said medical image studies likely to have been updated most recently in response to at least one of, (a) a last modified indicator indicating a last modified time or date, (b) a largest number of series of images and (c) a derived value provided by a function of image identifier values associated with individual studies of said identified medical image studies.

21. A system according to claim 20, wherein
said image data processor determines said study of said medical image studies likely to have been updated most recently by determining the largest number of at least one of, (i) instances of series of images and (ii) individual images, in a medical image study.

22. A medical image data acquisition and merging system, comprising:
a plurality of sources of medical image data accessible via a network, said medical image data comprising one or more sets of medical images of a particular patient individually including an associated medical image set identifier;
a search processor for automatically initiating a search of said plurality of sources to identify existence of sets of medical images of a particular patient having a duplicate first medical image identifier, in response to a user command to access a set of medical images having said first medical image identifier; and
an image data processor for,
determining identified sets of medical images having said duplicate first medical image identifier are substantially identical in response to at least one of, (a) a last modified indicator indicating a last modified time or date, (b) a largest number of series of images and (c) a derived value provided by a function of image identifier values associated with individual studies of said identified medical image studies and
merging identified sets of medical images determined to be substantially identical.

23. A system according to claim 22, wherein
said image data processor automatically determines identified sets of medical images having said duplicate first medical image identifier are substantially identical and automatically merges identified sets of medical images determined to be substantially identical.

24. A system according to claim 22, wherein
said image data processor determines identified sets of medical images having said duplicate first medical image identifier are substantially identical and merges identified sets of medical images determined to be substantially identical, in response to user command.
